(19) United States
(12) Patent Application Publication
(10) Pub. No.: US 2019/0009180 A1
(43) Pub. Date: Jan. 10, 2019

(54) My DollZ Digestive System

(71) Applicant: Jacinta Lawson, New York, NY (US)

(72) Inventor: Jacinta Lawson, New York, NY (US)

(21) Appl. No.: 15/626,128

(22) Filed: Jun. 18, 2017

(51) Int. Cl. A63H 3/00; G09B 23/30; A63H 3/24

(52) U.S. Cl. CPC A63H 3/001; A63H 9/00; A63H 3/24; G09B 23/303

(57) ABSTRACT

“My Dollz Digestive System”, which will be made in many sizes, which can be secured and unsecured to many dolls of many sizes, is a transparent, portable, simplified, toy version of the Digestive System that is in most animals. My DollZ Digestive System therefor, is a toy part that can be attached to dolls of many size after which it will allow children to feed liquid (water) to any doll that they attached it to and watch that liquid flow to each part of the simplified digestive system that is similarly to the digestive system in most animals, all of whom do drink, and wet. The electronic version which intakes lights as a food source will circulate the light throughout the digestive system as if it were alive however it does not produce liquid at the end but a light indicating that (the light) food source has reached the end of its cycle. The My Dollz Digestive System will also therefore, allow children who play with it, learn, and see a simplified path of the digestive system of most animals.

### CROSS REFERENCE TO RELATED APPLICATIONS

### Prior Art

Dolls with the ability to drink and wet: See (Patent numbers: (25388455, 5094644, dsc02806, dsc028419622306, 31178853, 9522261, 20010029146, 3514899, 3641703, 2080439, 2945321, 4115948, 51176561, 4135513, 255107, 3151787, 3237340, 3245174, 3061287, 4135513, 4570826, 4640424, 4693696, 4186573) and pregnant dolls that show inside their belly revealing their babies inside see (U.S. Pat. No. 5,308,277) etc.,

### STATEMENT REGARDING FEDERALLY SPONSORED RESEARCH OR DEVELOPMENT

“Not Applicable”—no text

### THE NAMES OF THE PARTIES TO A JOINT RESEARCH AGREEMENT

The names of the parties to a joint research agreement

“Not Applicable”.

### STATEMENT REGARDING PRIOR DISCLOSURES BY AN INVENTOR OR JOINT INVENTOR

Aug. 20, 2015, Copyright: Registration Number—(PAu 3-774-747) belongs to me. Yes, I owns the Copyright: Registration Number—(PAu 3-774-747) dated: Aug. 20, 2015 because after I told (the idea in this, my copyright) to “QUIRKY”, thinking that they were going to help me get a patent, I found out one day, after GOOGLING my name, that all my information, idea, and drawing were posted on the internet by “QUIRKY” for all to see.

Since I had no money and did not know how to get a patent, I got this copyright: Registration Number—(PAu 3-774-747), incorrectly thinking that it would protect my idea. Now, I am hoping to change my copyright, Date: Aug. 15, 2017 Copyright: Registration Number—(PAu 3-774-747) to a portable version and get a patent because it would be a different idea in that in addition to teaching children how the body processes food in the digestive system, because this system is now portable, it will allow them to put it on, and use it to feed and watch all of their beloved toys digest food and leave them to remain loyal to their favorite brands of toys.

### BACKGROUND OF THE INVENTION

### Field of invention

Toy.

(2) Even though I must leave my original Copyright: Registration Number—(PAu 3-774-747) idea because it was exposed and made unpatentable as I mentioned in section (F), I still wanted to create a doll with a digestive system in order to reveal what happens (inside the body or doll) when liquid is ingested and that is because even though dolls with the ability to drink and wet have been deemed educational, are greatly desired, and well loved by the public for many decades, I believe that more teachable moments can be added to even those dolls.

In addition, since children learn from viewing and interacting with things, I believed that adding a toy version of the digestive system or the My Dollz Digestive System to dolls would make more teachable moments possible.

The My Dollz Digestive System, which is a transparent, and now different because it is a portable, and simplified toy version of the Digestive System that is in most animals, attempts to make this more teachable moment possible by allowing children to add My Dollz Digestive System to any doll, which when used, allows children to see, because of its see through property, the path that all fluid that is ingested takes as they goes from one transparent organ to the next before being eliminated.

This is the reason why I believe that this portable, My Dollz Digestive System makes it even easier for more children to be entertained, be stimulated, view, and learn even more about the digestive system that is in most animals when they add it to their favorite doll and toy animal.

In summary, I am hoping to get a patent because I am changing my Copyright: Registration Number—(PAu 3-774-747) idea by making a portable version. This portable version also does not pressure consumers to buy a doll or toy animal from a stranger like myself, but instead encourages them to add it to their favorite toy, which will increase the number of consumers who will learn about the digestive system from using my, My Dollz Digestive System on any doll or animal toy that they already love, own, or wish to buy.

### DESCRIPTION OF RELATED ART INCLUDING INFORMATION

“Not Applicable”.

### BRIEF SUMMARY OF THE INVENTION

The reason that I believe that the My Dollz Digestive System which is a transparent, portable, made in many sizes, can be secured and unsecured to many doll of many sizes, is a greatly entertaining and educational, simplified toy version of the digestive system that is in most animals is because it will allow children for the first time, after they put it on any of their animal toys, and then use it to feed that toy liquid, to watch and learn for the first time, the path that the liquid travels through the digestive system before the toy wets itself.

Please refer to FIGS.(2B & 3)-8 for a full understanding of the following information. To make My Dollz Digestive System portable, the My Dollz Digestive System will have:

Velcro Stickers (the smooth sided ones) come attached near the mouth area, on the throat area, on the stomach, and near the exit of the My Dollz Digestive System. Corresponding (rough sided) Velcro stickers will also be included with My Dollz Digestive System so that consumers will be able to stick these corresponding Velcro stickers onto the areas on their dolls below where the velcroid areas on the mouth, throat, stomach anus on the My Dollz Digestive System reaches then, press the areas together to have the My Dollz Digestive System secured and become the digestive system of their dolls.

Two fasteners. Yes, My Dollz Digestive System will also have two Fasteners, one on the top, reference letter, T and one on the bottom, reference letter, B, on it, which will allow consumers to remove it from and secure it to dolls (toys) of many sizes. These Fasteners will be belts with a buckle on one end and smooth side Velcro on the other ends. These front view of the Fasteners is FIG. 2F-8 & their back view is (FIG. 4-8).

Two Fasteners will also come with their middle sections, reference letter: M, on their fronts sides (FIG. 2F-8), factory attached to the back of the top and bottom parts of the Large Intestine that is on the My Dollz Digestive System. FIG. 5-8 illustrates this.

In addition, each Fastener (belt) will be long enough so that consumers can fasten or unfasten the My Dollz Digestive System, its back view FIG. 3-8, to the back of their dolls, as illustrated in (FIG. 6-8), smooth side Velcro will come factory attached near the end, reference number 60 on the Fasteners that come attached to the top (T) and Bottom (B) sections of the Large Intestines that are on the MDDS.

Then consumers will be asked to attach provided rough sided Velcro stickers to area #70 in views, (FIG. 4-8) & (FIG. 5-8) which is below where reference#60 in (FIG. 3-8) reaches after it goes through the N-H-M-S-B and then press these areas together so that the Velcro will stick together and help secure the ends of fastener.

### BRIEF DESCRIPTION OF THE SEVERAL VIEWS OF THE DRAWING

The following is a listing of all figures by number with corresponding statements explaining what each figure depicts:

FIG. 1-8—view of My Dollz Digestive System before Fasteners are attached to the MDDS.

FIG. 2B-8—Back of Fastener and all that comes with them.

FIG. 4-8—Front of a FASTENER and all that come with them.

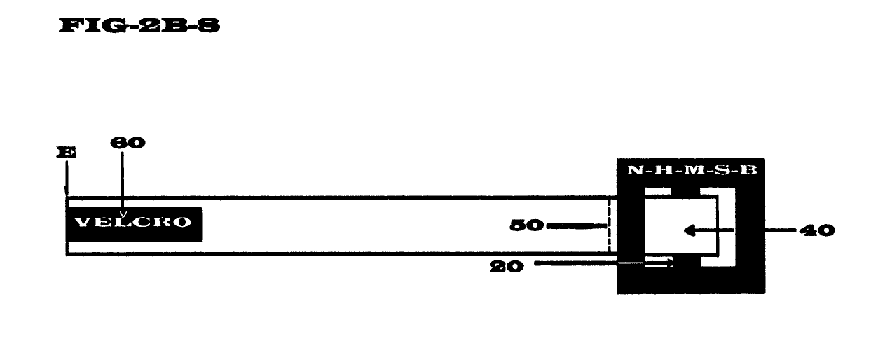

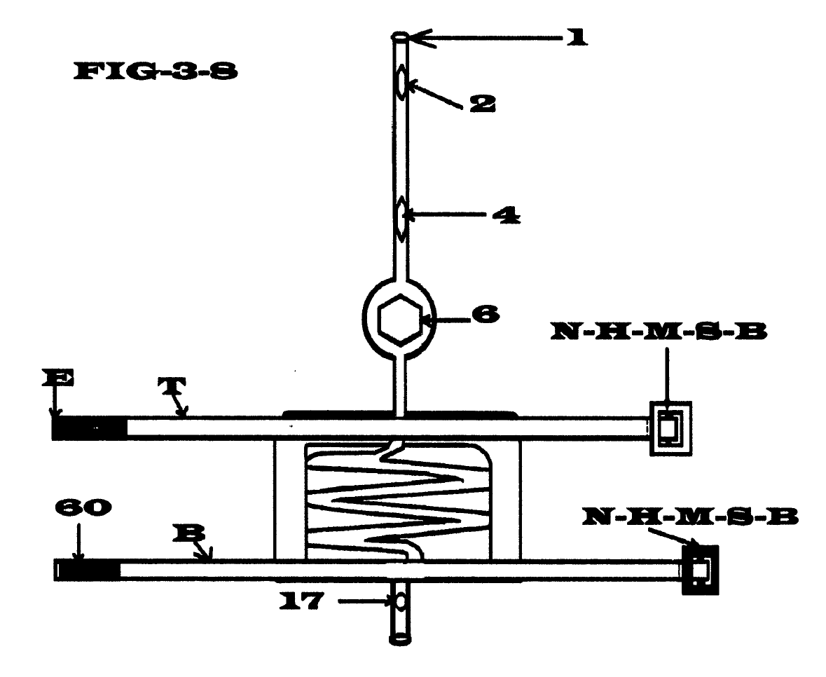

FIG. 3-8—Back of the My Dollz Digestive System when the Fasteners are attached by the factory and you can also see the front view of the Fastener depicted in FIG. 2B-8.

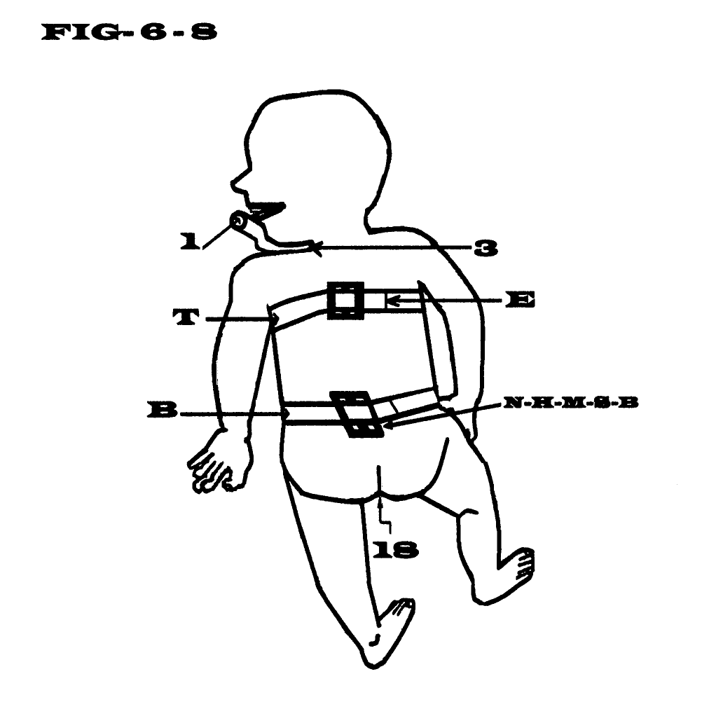

FIG. 6-8—Back of the My Dollz Digestive System on a doll.

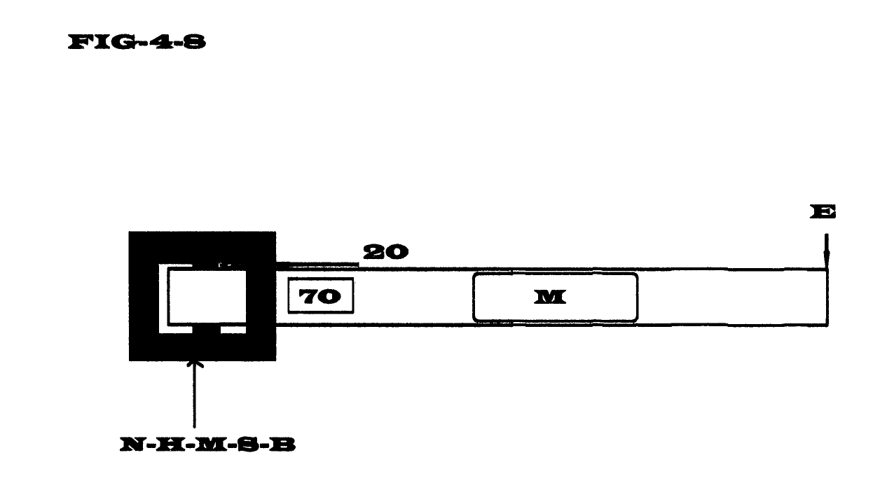

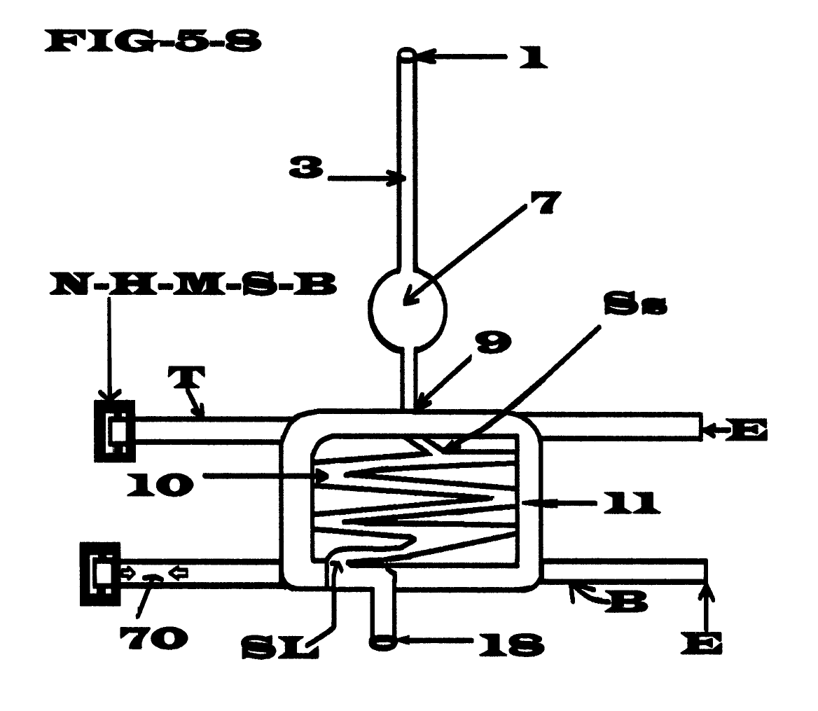

FIG. 5-8—Front of the My Dollz Digestive System and you can also see the back view of the Fastener depicted in FIG. 4-8.

FIG. 6-8—Front of the My Dollz Digestive System on a doll.

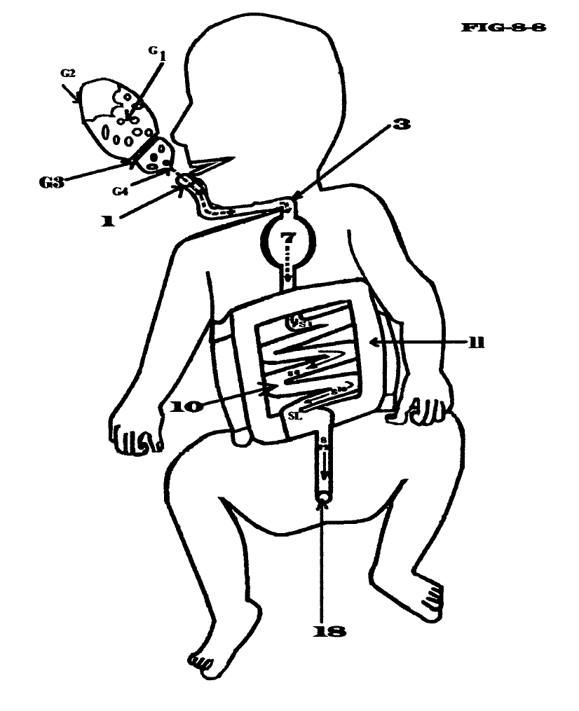

FIG. 8-8—Front view of the Flow of food in the My Dollz Digestive System when it is attached to a doll.

### DETAIL DESCRIPTION OF THE INVENTION

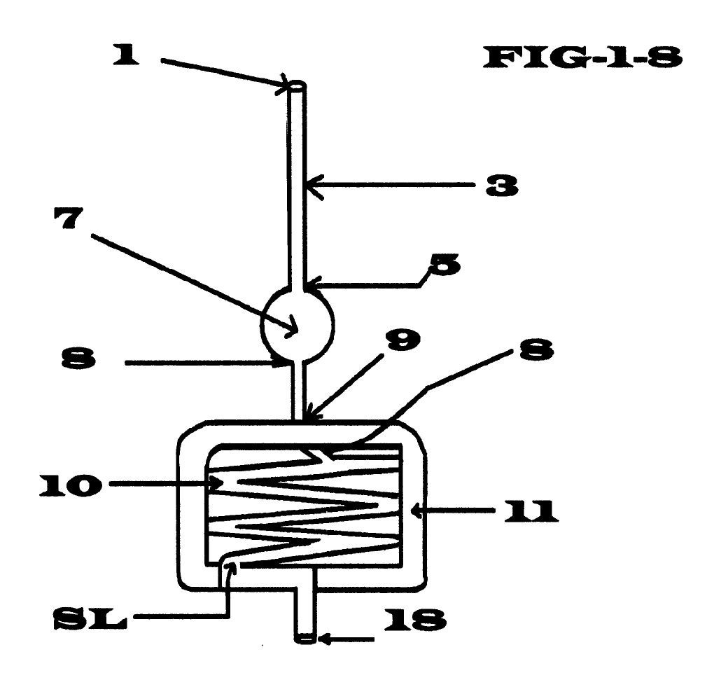

The following parts are on FIG. 1-8, which is a front view of the My Dollz Digestive System without Fasteners attached to it:

1—Mouth opening.

2—Velcro on mouth area used to help keep the MDDS attached to the mouth area on consumer's toy.

3—Throat section.

4—Velcro on throat section, placed to help keep the MDDS attached to throat area on consumer's toys.

5—Entrance to Stomach.

6—Velcro on Stomach used to help keep the stomach of the MDDS attached to the stomach. section on consumer's toy.

7—Stomach.

8—Stomach exit.

9—tube from the bottom of the Stomach leading to the start of the Small Intestine.

Ss—Beginning of Small Intestine.

SL—Small Intestine deposits into bottom of or start of the Large Intestine.

10—Small Intestines.

11—Large Intestine.

17—Velcro near Exit, placed to help keep the EXIT, (#18) of the MDDS attached to groin area on consumer's toys.

18—Exit or anus.

FIG. 4-8), the front & (FIG. 2B-8), the back of the type of the Fasteners that will be attached to the top T, and bottom, B, parts of the Large Intestine respectively. The following are the parts that are on both the front FIG. 4-8 and the back-side FIG. 2B-8 of the Fasteners that will comes factory attached to the My Dollz Digestive System so that consumers will be able to secure the My Dollz Digestive System to their toys:

No-Hole-Metal-Slide-Buckle—buckle attached to Fasteners, to help tighten and loosen the Fasteners.

20—Middle section on the No-Hole-Metal-Slide-Buckles where the material part of the Fastener laps over and is then stitched on to make the Fastener, a fastener with a N-H-M-S-B.

E—End of Fastener.

40—End part of material part of the Fastener that the factory puts over part #20 on the No-Hole-Metal-Slide-Buckle then stitches the material to connect the material part and N-H-M-S-B come together to form the one unit know as a Fastener.

Part #50 and part #60 below are only visible on (FIG. 2B-8) the back side of the Fastener.

50—The visible stiches from the factory sewing on the Fastener onto the No-Hole-Slide-Metal-Buckle.

60—Velcro that the factory will put near the End, areas E of the Fastener.

The following parts are only visible on the front sides of the Fastener FIG. 4-8:

70—Customers will put matching Velcro in this section (#70), then press it together with on area #60 to keep the End of the Fastener E, down once it goes through the, No-Hole-Metal-Slide-Buckle after they attached the MDDS to their doll (toy).

M—middle section on the Fasteners or belt that will come attached to the top and bottom part of the Large Intestine section of the My Dollz Digestive System.

FIG. 3-8 drawing and description of a back view of My Dollz Digestive System with Fasteners attached has the following parts:

1—Mouth opening.

2—Velcro tape on mouth piece.

3—Throat section.

4—Velcro tape on Throat.

5—Entrance to Stomach.

6—Velcro tape on Stomach.

7—Stomach.

8—Stomach exit.

N-H-M-S-B—Buckle part of the Velcro Fastener (T) which is glued to top part of the Large Intestine.

Ss—Beginning of Small Intestine.

E—End of Top Fastener T.

11—Large Intestine.

SL—Small Intestine deposits into beginning of Large Intestine.

M—middle section on front of FASTENER, B (bottom fastener)—It is glued onto bottom the Large Intestine so that area is shown in grey.

60—Velcro that the factory will put near this End section of the Fasteners.

17—Velcro tape on exit.

18—Exit or anus.

The following parts of FIG. 6-8 back of My Dollz Digestive System are visible when it is attached to a conventional doll:

1—Mouth of My Dollz Digestive System which is attached below the bought doll's bottom lip.

2—Velcro tape on mouth area of the My Dollz Digestive System.

3—Throat of My Dollz Digestive System

4—Velcro tape for on Throat section of the My Dollz Digestive System.

N-H-M-S-B—buckle on Fastener T, which is glued to top part of the Large Intestine.

E—end of Fastener T, which is glued to top part of the Large Intestine and is now buckled onto the back of a conventional doll.

e—end and back of left half of Fastener B, which is glued to bottom part of the Large Intestine and is now buckled into the N-H-S-buckle of Fastener at the back of the conventional doll.

18—Exit of My Dollz Digestive System.

The following are the parts on FIG. 5-8 front view of My Dollz Digestive System with fasteners attached:

1—Mouth.

3—Throat.

5—Entrance to Stomach.

7—Stomach.

8—Stomach exit.

N-H-M-S-B—Buckle on Fastener T which is glued to top part of the Large Intestine.

E—End of Fastener T (top one) that is glued onto the top part of the Large Intestine.

N-H-M-S-B—Buckle on Fastener B.

E—End of Fastener B (lower one) that is glued onto the bottom part of the Large Intestine.

Ss—Beginning of Small Intestine.

11—Large Intestine.

SL—Small Intestine deposits into bottom (start) of Large Intestine.

70—where customers would put the corresponding (rough sided Velcro) then stick together with the Velcro on part #60 (that is on the back side of the Fastener) after the end of the Fastener goes through the buckle. This is done to keep the end of the Fastener down and keep it from moving.

18—Exit.

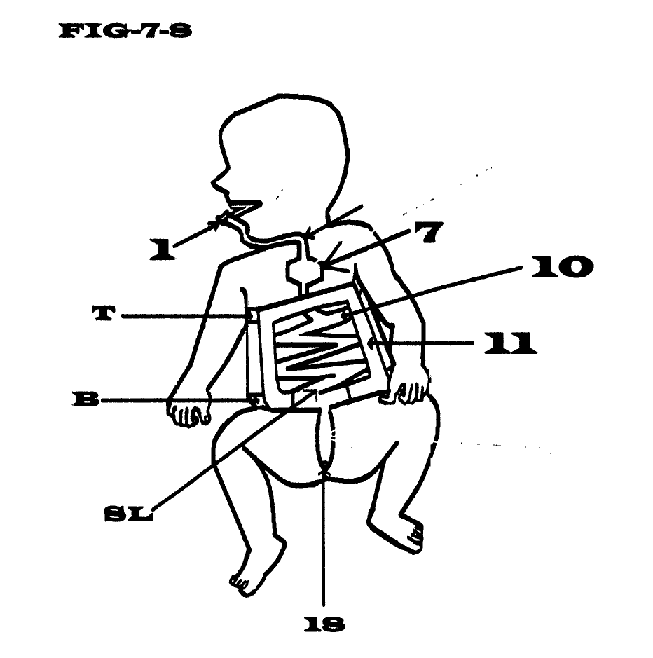

The following parts are on FIG. 7-8 front of My Dollz Digestive System when it is attached to an actual doll:

(2,4,6,17)—areas that will come with Velcro attached to them and I indicate that by drawing them in grey.

1—Mouth of My Dollz Digestive.

3—Throat.

7—Stomach.

11—Large Intestine.

10—Small Intestines.

SL—Small Intestine deposits into bottom (start) of Large Intestine.

1—Mouth opening of My Dollz Digestive System attached below the bought doll's bottom lip.

3—Throat.

18—Exit of My Dollz Digestive System glued to exit part of doll bought.

“My Dollz Digestive System”, is a revolutionary new informative addition to the toy industry because it will be made in many sizes, can be secured and unsecured to many dolls of many sizes, and is most importantly a transparent, portable, simplified, toy version of the Digestive System that is in most animals that has never been constructed before. My DollZ Digestive System, a toy part that can also be attached to dolls of many size after is educational because it will allow children to feed liquid (water) to almost any doll that they attached it to and watch that liquid flow to each part of (please refer to FIG. 8-8, from reference: #1 to #3 to #7 to #9 then downwards to #10—the Small Intestine. Then, inside the Small Intestine the liquid will flow from:

s1 to s2 all the way.

to s10.

Then at (s10), the end of the Small intestine, the liquid will flow to

the end of the Large Intestine SL, (the beginning of the Large Intestine).

And from SL, the liquid will then go to & out of part #18 (the Anus) of this simulated & simplified, digestive system that is similarly to the digestive system in most animals and know to us now as the My Dolls Digestive System.

How to attach the My Dollz Digestive System to your doll. I will use MDDS as an abbreviation for My Dollz Digestive System:

Place rough Velcro under your doll's chin.

Press part #2 on the MDDS onto that Velcro that you applied in step 1 so that they stick together, and the tube stays down.

Continue to run that tube section of the MDDS under the neck and throat of your doll.

Place one of the rough Velcro's below where Part#4 on the MDDS hits your doll.

Press part #4 on the MDDS onto the Velcro that you attached in step (4).

Run the rest of the MDDS along your doll's chest.

Place one of the rough sided Velcro below where part#6 on the MDDS hits your doll.

Press part #6 on the MODS onto the Velcro that you just attached to your doll in step (7).

Take the buckle part and End part of the Top Fastener (T) to the back of your doll and

push the Velcroed end part of Fastener T through its buckle (as you do with No-Hole Metal-Slide-Buckles).

If you have never used a No-Hole-Medal-Slide-Buckle, you can think of doing step (10) by saying that you will push the end of Fastener T (part E) above & over part #20 on the fastener (or you can think of it as if you were pushing the end of the Fastener through the open parts on the rectangular buckle).

Now that the end of Fastener T went through the buckle of Fastener T, attach a rough Velcro below the place where the end of Fastener T reaches.

Next, press the Velcroed end (reference #60) of Fastener T onto where you put the Velcro in step (12) until the end of Fastener T stays down.

To buckle the bottom Fastener (Fastener B), repeat step (9 through 13) again with Fastener B instead.

Next, continue to run the MDDS along the groin of your doll and

place a rough Velcro below where reference#17 on the MDDS stops (on your doll).

Press part #17 (the Velcro that is on the MDDS) onto that Velcro threat you applied in step (16) until the MDDS's part #17 stays down.

The My Dollz Digestive System is now ready to use.

Paragraph above has just explained how to attach the My Dollz Digestive System to a doll. Next, are the instructions on how to use the My Dollz Digestive System. To use the My Dollz Digestive System, consumers must put pampers on their doll once they have attached the My Dollz Digestive System to their doll and insert a bottle into the tube (mouth) opening of the MDDS. Please note that when consumers put pamper on their dolls, part numbers (17 & 18) will be covered by the pampers.

Next, as illustrated in FIG. 8-8, after a bottle is inserted into the mouth (the opening to the tube part) of My Dollz Digestive System, the liquid part #(G1) in the toy bottle will flow:

to the throat (part #3) of the My Dollz Digestive System and

then directly and exclusively into a replica of the stomach (part #7)

From there, the liquid will flow directly and exclusively to a replicated system known as the Small Intestine in all animals (part #10).

Then from inside part #10—the Small Intestine, the liquid will flow from s1 all the way to s10.

Then the liquid will flow to where the Small intestine meets, the Large Intestine part SL (the beginning of the Large Intestine but I cannot change my drawing now).

And then from there, the liquid will go down to & out of part #18 of this simulated & simplified digestive system that is similarly to the digestive system in most animals and know to us now as the My Dolls Digestive System.

My DollZ Digestive System would be recommended for children 3 years old and over. I will now list the measurements and s then the descriptions that I used to make and test my My Dollz Digestive System a doll that is 1 ft tall.

The measurements of the front of the doll used were:

The stomach of the doll was ¾ inches high and ½ inch wide.

Neck length= 12/16 in.

Neck width 1 10/16 in.

Chest and side widths=3 in.

From the top of the doll's neck to its groin,=4½ inches.

From the bottom of the doll's lip to the bottom of the doll's neck=1½ in.

From the top of the shoulder of the doll to the doll's breast=1½ in.

The length of the doll's chest=3 in.

The middle of chest to middle of back of doll used=4¼ in.

Under the doll's arm to the hip=3 in.

Shoulder to doll's hip=3½.

The circumference around the doll to back of the Left front side to right front right side of the doll=4 in.

The width from below the middle of the doll's arm to the back of the doll is ½ in.

For a full understanding of the following paragraph that describes where the Velcro will come factory attached on the MDDS please refer to FIG. 5-8. The My DollZ Digestive System will have the soft part of Industrial Strength Velcro brand stickers just below the mouth part #(2) which is inches from the mouth piece of the My DollZ Digestive System. Then 2 inches from the start of the My DollZ Digestive System a smooth-sided Velcro sticker would be placed, that is (part #4). Then the we would be ½ inches before the entrance to the stomach (part #5). Next, we would place a smooth sided Velcro sticker on the back of the stomach (part #6) making sure the Velcro sticker on the stomach is placed exactly in the middle of the back of the stomach. Then, about ½ inches from the anus or exit, at part #18 of the My Dollz Digestive System, a Velcro sticker would be placed; this sticker is part #17.

In addition, consumers will be given a supply (roll) of (VELCRO Brand One Wrap Thin Ties, Black, 8×½-Inch, 100 Count (91140 found on amazon Dec. 16, 2017) the rough sided Velcro stickers to cut and attach to where these parts of The My DollZ Digestive System that has the Velcro stickers on them reaches on their dolls.

Lastly, and for full understanding of these descriptions about the fasteners, please refer to FIG. 2F-8 & FIG. 4-8. Now, two Belted Fasteners will be attached to the back of the My DollZ Digestive System. One Fastener, (T) will be attached at the top area near part 9 of the Large Intestine which is above where the Small Intestine (Ss) starts. The other Fastener, (B), will be attached to the bottom part of the Large Intestine.

Each Fastener will be long enough so that consumers can fasten or unfasten the My Dollz Digestive System to the back of their dolls by putting the unbelted end E, of each fastener into the N-H-M-S-B buckled ends B, then cutting and putting the included rough Velcro stickers below, on area #70, which is where the ends of each Fastener reaches. Consumers would have to next press the Velcro on the end of that Fasteners into the Velcro that is now on part #70 to keep the ends of these Fasteners in place.

To make my “My DollZ Digestive System” myself, I would make sure I stay away from cancer causing vinyl Tubing. My DollZ Digestive System would be recommended for children over 3 years old. The sentence below is should be here instead to make the Large and Small Intestines of the My DollZ Digestive System, I would have to purchase:

3 ft. of ⅛ I.D.× 3/16 O.D. Clear Vinyl Food Grade Laboratory Tubing which I will buy on Amazon, will be the tube that I use as the mouth and will go from the doll's bottom lip, then become the doll's throat, and then name & use as the Small Intestine.

Clear DIY Fillable Plastic Ball Craft Ornaments 12-13 Mm if not available, a clear medium hard plastic oblong object oblong and one that is cone shape. I would purchase this to make the stomach.

The 2 ft. of 3/16 I.D.× 5/16 O.D. Clear Vinyl Food Grade Laboratory Tubing available on amazon will be used to construct and be known as the Large Intestine.

I would also buy supplies to make “My DollZ Digestive System” by going to a hobby shop and to buy dolls' bottle, I would look for ones that have removable nipples; nipples (ref. #G4 in FIG. 8-8) that are hard and bottles that are semi-hard.

To Glue (I would go to) http://3W-DOTwikihowDOTcom/Glue-Plastic and obtain the following information.

Look for a recycling symbol. Different varieties of plastic require different glues. The easiest way to identify the type is to search for a recycling symbol on the plastic itself, the label, or the packaging the object came in. This symbol is a triangle formed by three arrows, and contains a number, letter or both inside or below the triangle.

Learn how to glue plastics marked 6. A recycling symbol containing a 6 or PS signifies the plastic type “polystyrene”. This is best glued with a poly cement (also called plastic cement), or a specialized plastic glue such as Loctite Epoxy Plastic Binder or Super Glue Plastic Fusion. Other adhesives that will work include a cyanoacrylate (also called “instant glue” or “cyano”), or an epoxy.

Select a specialized glue for plastic marked 2, 4, or 5. If your material is labeled 2, 4, 5, HDPE, LDPE, PP, or UMHW, you have a type of “polyethylene” or “polypropylene”. These plastics are much more difficult to glue, and you'll need to look for a specific product that names these types on its label, such as Loctite Plastics Bonding System or Scotch Weld DP 8010.

Make the right choice for plastics marked 7 or 9. The miscellany category marked 7 or the ABS type marked 9 can indicate a variety of plastic resins, with many possible letters indicating subtypes. Your best bet for gluing it is an epoxy or cyanoacrylate.

Try to identify the plastic type in other ways. If there is no recyclable system, you may have to guess at which type of plastic it is before you can select a glue. Here's a guide to help you accomplish this task.

Lego bricks are made from a type of plastic called “ABS ” and are best glued using epoxy cement. ABS solvent cement will also work but may alter the shape of the material's surface. imitation glass, cheap toys, CD cases, and similar brittle, often clear plastic is usually “polystyrene” and can be glued using several adhesives. For best results, use a poly cement or a glue advertised for plastic bonding.

Glue tough, hard plastic found in bottles, buckets, crates, and food containers using a product that specifically advertises the ability to bond “polyethylene” and “polypropylene”, are impossible to glue by most normal methods, so don't assume a product labeled “for plastic” will work unless it specifically mentions “polyethylene” or “polypropylene”. I would make sure I stay away from cancer causing vinyl Tubing and is what I would buy for the doll I tested it for use on.

To make the BELT FASTENERS:

I would buy Reusable Cinch Straps ¾″×8″-12 Pack, Multipurpose Quality Hook and Loop Securing Straps—Plus 2 Free Bonus Reusable Cable Ties from Amazon which has buckles on them to lock them. I would have the hobby shop cut the width of them into.

Then starting in the middle of this width cut into 3, Reusable Cinch Straps ¾×8″-12 Pack, Multipurpose Quality Hook and Loop Securing Straps, I will glue the middle length of this strap to the top, back middle section of the Large Intestine and continue to glue the now left and right parts of it to the left and right side parts of the Large Intestine until I reach the end of each side of the Large Intestine and this would then be Fastener T as illustrated in FIG. 3-8 and then I would do the same to the bottom section of the Large Intestine that is at the bottom to create the bottom fastener (B). For further described in DETAIL DESCRIPTION OF THE INVENTION and other places in this document.

In conclusion, if I could not find a hobby shop that sells kits that can glue parts together to the My DollZ Digestive System, then I must attach or glue the parts of the different sections of the My Dollz Digestive System myself using the following materials here for making plastic.

Using the measurements in paragraph above to make the stomach on a the My Dollz Digestive System for this doll that is 1 foot tall, one would say that the stomach of the My Dollz Digestive System would be:

¾ inches high and ½ inches wide.

Would have a circle opening at the top where the tube coming from the throat would be attached and then another opening in the middle of its bottom where next the tube running down to become the Small Intestine would be attached.

The stomach would therefore be attach 1¾ inches below the mouth piece on the My Dollz Digestive System. And the stomach would end ¾ inches below that or (2½ inches) below the mouth piece of My Dollz Digestive System.

The doll that I bought, made and tested My Dollz Digestive System for use on was 1 ft tall and from the neck to the groin, the length was 4½ inches. Therefore, the stomach that I must make for my, “My DollZ Digestive System must be ¾ inches high and ½ inch wide. This means that to make the stomach of my “My DollZ Digestive System”:

I would have to buy something that resembles a stomach, like a Clear DIY Fillable Plastic Ball Craft Ornaments 12-13 Mm for example or make a stomach out of an object that is oblong shape at the top and cone shape at the bottom. If I did not find that, then I would have to buy an object that resemble those 2 shapes.

Then cut the oblong shape in two at the middle and glue or ask the hobby shop to glue one half of that to a cone shape object.

Then I would take the 3 ft. of ⅛I.D.× 3/16 O.D. Clear Vinyl Food Grade Laboratory Tubing and inform the hobby shop that I am going to be naming it the Small Intestine and the 2 ft of 3/16 I.D.× 5/16 O.D. Clear Vinyl Food Grade Laboratory Tubing, (the Large Intestine tube).

Then I would ask the hobby shop if they could cut off 2½ inches off the Small Intestine tube and then make a (C=3.14× 3/16=or a 0.58875 inch diameter) hole at the top and in the middle of the oblong part of the stomach replica.

Then after that, I would ask them to insert ½ inch of that Small Intestine tube into the stomach replica and then airtightly glue the part where the Small Intestine enters the stomach, to the opening of the hole in the stomach so that the two shapes become one.

Next, I would ask them to repeat everything that they just did but this time I would ask them to make the hole in the middle of the bottom part of the stomach replica and that they glue to that hole the end of the leftover part of the Small Intestine tube.

To Make the Small Intestine section of the My Dollz's Digestive System:

Please look at FIG. 1-8 which shows the front view of the project to be made and known as My Dollz Digestive System.

I would also have to ask the hobby shop to construct the Small Intestine by asking them to allow the tube coming from the bottom of the stomach of the My Dollz Digestive System to have a straight length of 1¼ inches.

Then I would tell them that I need them to turn the tube for 1 inch to the right.

Also, that after that they must tilt the tube ⅛ inches just before they turn it to the left for 2 more inches.

Next, I would tell them to fix the tube after (where the tube changes direction) on this turn and after all the other turns.

Also, that when they tilt it make sure that it tilts (in such a way that the liquid can flow easily from the last direction to the new direction that the tube is going).

Then after that last 2 in turn to the left, I would ask them to continue by turning the tube to the right for 2 inches.

Then left for 2 inches.

Then to the right 1⅛ in, remembering that they must always tilt the tube ⅛ in down after each turn.

Also, because of the amount of times that I must bend the tube of the Small and Large Intestines, when I do construct the Large Intestine, I would also ask the hobby shop to cut those intestines and attach bendable parts wherever the Intestines bend or change directions in order to maintain the circumference necessary to maintain the consistent flowing of liquid throughout the MY Dollz Digestive System when liquid is introduced and being fed to the toys.

Next, we need to make the last left turn that the Small Intestine makes with the Small Intestinal tube.

Then, we must go 1⅛ in the left direction with that Small Intestinal tube.

Next, we must cut the rest of that Small Intestine tube off because we are now at point (SL), where the Small Intestine ends and the Large Intestine begins and then takes over. Therefore, I would:

cut a ⅞-inch-long piece off the Long Intestine tube and set it aside.

Next, we are going to construct the Large Intestine which is sealed up (no feeding enters the Large Intestine because the Large Intestine in the manual version of the MDDS, is only present for correctness). Therefore, cut off 3 inches from the L.I. tube and cut the tube down the middle and cut is so that you can cut out 2 disks with an outside diameters of 5/16 in.

Next line up the outside opening of one end of the ⅞ in-long Large Intestine tube that you cut off in step 14 with it and seal that opened end closed with one of the 5/16 in disk by gluing it onto that end. This will be the Beginning of the Large Intestine. Therefore, mark this end of the L.I tube with the letter,” B″, for beginning with fingernail polish.

Repeat step 16 with the other end of the ⅞-inch-long L.I. tube end mark this with the letter, “E”, for the end of the L.I. tube.

Next, we need to attach the small intestine to the large intestine at point SL, where the Small Intestine ends and the LI begins, and we will attach the S.I. tube on the top of the ⅞ in long piece of the L.I tube that we have cut and sealed closed so that no fluid coming from the Small Intestine from entering the other parts of the Large intestine. Therefore, we must make a ⅛-inch diameter hole on the top of this ⅞-inch-long tube about ½ inches from the left sealed end or the end that has the letter “B” marked on it.

NEXT, line up the inside diameter of the end of the Small Intestine tube that is at (SL) with this ⅛ in hole on the top of the L.I. tube.

Next, we must mark around the outside diameter of the Small intestine while it is on top of the opening hole that we made in the ⅞ -inch-long piece of the L.I. tube.

Next, remove the S.I. tube from on top of the hole and put a small amount of glue in the opening edges of the hole and inside the circle that we made marking the outside diameter of the S.I tube was when it was on the top of the ⅞ inch-long L.I. tube.

Next, glue the end of the Small Intestine tube at point SL to this hole.

Next, travel left for about ¾ inches and mark off that length with scotch tape or fingernail polish.

Then, travel up for about 2-inches encasing the small intestine.

Mark this 2-inch length off with scotch tape.

Then with that 2-inch marked off section, please glue the Large Intestine tube to the Small Intestine around all the points where the Small Intestine changes direction on that left side of the My Dollz Digestive System. The places where the SI changes direction look like where reference #10 points to on FIG. 1-8 (These are places where the Small Intestine touches the Large Intestine at an angle).

Next, turn right for about 2 in encasing the small intestine at the top. We must also as we go right for 2 inches, pass in-front of the Small Intestine tube at reference points (9 in FIG. 1-8) coming from the bottom of the stomach.

Next, we will go down for about 2 in (you should be a little above the level of the point SI.)

Next, turn left for ⅞ inch and mark off this ⅞ inches with this tube with fingernail polish.

Next, cut off the rest of the L.I. tube from it.

Next, glue the end of this tube to the sealed end of the ⅞ -in-long L.I. tube that was marked with the letter, “E” in step 17.

Next, we need to make points (17 and 18 that are on FIGS. 1-8). Since the tube that is attached and makes these points on the FIGs are the size of the Large Intestine tube, with a 3/16 in I.D we must cut a hole that has a diameter that is a little smaller than that. Therefore, at about 1/16 inches from the letter marked as “B’ on the ⅞-in-long L.I. tubes, we must cut a circle that has a diameter of ⅛ inches.

Next, cut off 1 inch off the unused Large Intestine tube.

Then, line up the opening of that 1-inch long piece of the L.I. tube and glue this 1 in piece of L.I. tube to the hole that you just made. This 1-inch long tube is point 17 and point 18 (the Exit or anus of the My Dollz Digestive System which is about 5.25 inches after the mouth of My Dollz Digestive System). Now we are done constructing the Large Intestine and the Anus of the MDDS. Thank you.

To Make and attach the Large Intestine section of the My DollZ Digestive System, I would also have given the 2 feet of the 3/16 I.D.× 5/16 O.D. CLEAR VINYL FOOD GRADE LABORATORY TUBING to the hobby shop. Then I would ask them to make a 0.58875 in diameter hole at 1 inch before the end of one end of the 3/16 I.D.× 5/16 O.D. Clear Vinyl Food Grade Laboratory Tubing.

Then I would ask them to make sure that the hole of the Small Intestine is air tightly glued to the Large intestine. I want the Small Intestine to be glued completely over the hole that was made to the Large Intestine.

Then, I would also ask them to also glue this entire 1-inch right side of the Small Intestine to the inside circle of the Large Intestine. And while continuing to run the Large Intestine around the Small Intestine to make sure to glue the Large Intestine to the Small Intestine every place that the Small Intestine changes direction (wherever the Small Intestine touches the Large Intestine).

When Consumers purchase the My Dollz Digestive System, I would advise consumers that they would need to purchase conventional doll pampers and conventional dolls' bottles (dolls' bottles that will allow consumers to fill them with water and which also allow the doll to drink from it) from a doll parts store or online or from places like “Toys R US”. I would also advise them to make sure that the nipple opening on the doll bottle that they buy have a diameter of 1/32 inches (1 mm) or less when they purchase My DollZ Digestive System so that they have everything needed to make experiencing the My DollZ Digestive System the greatest, most educational, and most fun experience that they ever had in the safest manner possible.

I can also make my own dolls' bottle to accompany the My Dollz Digestive System if I found out that this type of doll nipple does not exist by getting a doll bottle from the hobby shop that is oblong, be of length 4 in with the nipple attached and not too hard or soft (made from a plastic like the Clear Vinyl Food Grade Laboratory Tubing).

Also, the top of this bottle which would be the section of the bottle that has the nipple on it (reference #G3 on FIG. 8-8), would have the ability to be screwed on and off, be of a length of 1 inch and made of hard plastic. The doll's bottle and nipple would be more than ⅕ inches the doll's size. The nipple (ref. #G4 in FIG. 8-8) would have a diameter that is ½ the inside diameter of the ⅛ I.D.× 3/16 O.D. Clear Vinyl Food Grade Laboratory Tubing (or ⅛ divided by 2 which is 1/16 inches) and the hole in the nipple (ref. #G4 in FIG. 8-8) would have to be ½ that size (about 1/32 of an inch).

Pampers that could accompany My DollZ Digestive System would be made of clear VINYL Food Grade Laboratory in the front and on the inside of the pampers, from ½ inch above where the middle of the doll's groin at the bottom part where the front of the doll meets the middle of the doll (just before the hole in the doll's exit) I would add cloth diapers or I could advise consumers that they would need to purchase conventional pampers to go with the My Digestive system that they purchase and will attach.

I could instead have a company make pampers by doing the following things:

I would buy Free fold (cloth diapers) and cut the Free fold into the shape of an underwear (panty, brief) that fits several sizes of dolls.

Then, I would cut another underwear (panty, brief) shape out of Vinyl Food Grade Laboratory Tubing plastic that, this time, is one size large than that underwear shape that I made with the Free fold (cloth Diaper).

Next, I would go and sew FOE elastic onto the edges of the top, bottom, and where the doll's legs will go on the Vinyl Food Grade Laboratory Tubing plastic underwear.

Then I would cut the underwear that I made from the Free fold (cloth diaper) into two pieces, separating the front part of the underwear from the back part of the underwear.

Next, I would attach the back part of the Free fold (cloth diapers) underwear to inside back part of the—Vinyl Food Grade Laboratory Tubing plastic underwear using one snap at the middle groin area, one snap on the left top edges at the back part of the underwear and one snap on the right-side edge at the top of the back part of the underwear. Or if I were to supply my own dolls' pampers there are lots of places on YouTube that teach you how to make diapers.

In conclusion, I think it would be best if I asked consumers to buy the conventional pampers and dolls bottles with the specification that I suggested from toy supply stores or hobby shops.

To feed “My DollZ Digestive System”, consumers would have to use a hard nipple and a medium soft bottle. I would also recommend that consumers to only feed the doll (My DollZ Digestive System), clean water and clean the My DollZ Digestive System and any bottle used to feed their (My DollZ Digestive System), toy, as often as the use them.

The bottle would come with the Electronic Version of the MY Dollz Digestive System because the bottle has the remote to control the lights.

I should just have consumers purchase diapers once they have purchased the Manual Version of the My DollZ Digestive System for the dolls (toys).

What is claimed as new and desired to be secured by My-DollZ-digestive-system in the U.S. is that My DollZ digestive-system is:

1. a toy for dolls which came up with in her copyright. Copyright: Registration Number—(PAu 3-774-747) Dated: Aug. 20, 2015 the TITLE OF WORK: My electronic and non-electronic Bio-Doll which simulate the digestive system, and is comprising of:
A simplified transparent digestive system with transparent (mouth) opening and other transparent members secured to it known as:
Stomach, Large intestine, Small intestine, Anus, and that:

2. My DollZ Digestive System is also now different because it:
I. will now be portable allowing consumers to add and remove it from their toy animals and dolls of different sizes and give any toy the ability to drink and wet.
II. will come in many sizes—thusly, giving almost any toy the ability to drink and wet.
Therefore, I also hope to claim as new and desired to be secured by My DollZ Digestive System in the U.S. the following parts that must be present to make the My Dollz Digestive System a transparent, portable toy version of the digestive system that is in most animals:
(I). 2 Belt Fasteners, (T) and (B), will be secured to the top and bottom parts, respectively, of the Large Intestine. The two belted Fasteners are viewable in (FIG. 2B-8, FIG. 4-8, FIG. 5-8) and (FIG. 3-8).
(II). Velcro Stickers will come factory attached near the mouth piece, on the throat piece, in the middle of the back of the stomach, and near the anus of the My Dollz Digestive System. Also, that corresponding Velcro stickers that will stick together with those stickers placed on the mouth piece, throat, anus, and on the back middle of the stomach of the My Dollz Digestive System will be included for consumers to stick on the corresponding stomach, anus, throat, and mouth areas on their toys to help secure the My Dollz Digestive System to their toys.

2(B). In conclusion, my claim is that my My Dollz Digestive System claims to be different from my Copyright: Registration Number—(PAu 3-774-747) because My Dollz Digestive System, not only, through its transparent nature, allows consumers to watch the liquid that they feed it, go on its journey from the mouth, to the stomach, to the intestines, and then out the anus of the My Dollz Digestive System as the copyright does but, the My Dollz Digestive System, will be made in many sizes, which will give consumers the ability to unsecured and secured it to many dolls(toys) of different sizes, another word for that is that the MDDS, will be portable and in doing so the My Dollz Digestive System will give almost any toy that consumers purchase, the ability to drink and wet.

4. Also claim is that My Dollz Digestive System can be made in an electronic version and in such:
(a) a bottle will be inserted into the system that activates lights which will simulate water flowing through the entire My Dollz Digestive System, from the mouth part, to the throat part, then to the start of the small intestine, then to the end of the small intestine then into the beginning of the large intestine all around the large intestine until it reaches the end of the large intestine and then into the exit of the My Dollz Digestive System.
(b). Also claimed is that this My Dollz Digestive System will have Fasteners (noted in the non-electronic version above in claim 2 and claim 3).
(c). Also claimed is that this electronic version of my My Dollz Digestive System will be battery operated and therefore an electronic cord that will be long enough to take it to the back of the doll where it's battery pack can be attached (with Velcro stick on) to the back of toys.
(d). Claimed also is that corresponding Velcro stickers will come with this electronic version of the My Dollz Digestive System.
(e). Also claimed is that the bottle will hold the remote that can also operate the lights in the My-Dol1Z-Digestive-System to act like flowing water when the bottle is inserted into the MDDS mouth and the button is pressed.
In conclusion, “My Dollz Digestive System”, which will be made in many sizes, will be able to be secured and unsecured to many dolls of many sizes, and thusly portable, is a transparent, simplified, toy version of the Digestive System that is in most animals that after it is attached to dolls of many size the, “My Dollz Digestive System”, will allow consumers to feed (liquid (water)) to almost any doll (toy) that they attached it to and watch that liquid flow to each part of the My Dollz Digestive System.
